(19) United States
(12) Patent Application Publication
(10) Pub. No.: US 2025/0092590 A1
(43) Pub. Date: Mar. 20, 2025

(54) METHOD FOR PROVIDING MOULDED AIR-LAID PULP

(71) Applicant: Green Sol-Gel Limited, Sittingbourne, Kent (GB)

(72) Inventors: Fanya Ismail, Sittingbourne, Kent (GB); Sheila Fattah, Sittingbourne, Kent (GB)

(21) Appl. No.: 18/577,005

(22) PCT Filed: Jul. 6, 2022
(86) PCT No.: PCT/GB2022/051741

§ 371 Date: Jan. 5, 2024

(30) Foreign Application Priority Data
Jul. 6, 2021 (GB) 2109753.0

(51) Int. Cl. D04H 1/26; B27N 3/00; B27N 3/12; B27N 3/18; B65D 81/03; D04H 1/732; D06M 13/503; D06M 13/507; D06M 15/03; D06M 15/11; D06M 101/06; D21H 27/10

(52) U.S. Cl. CPC D04H 1/26; B27N 3/002; B27N 3/12; B27N 3/18; B65D 81/03; D04H 1/732; D06M 13/503; D06M 13/507; D06M 15/03; D06M 15/11; D21H 27/10; D06M 2101/06; D06M 2200/10; D10B 2505/10

(57) ABSTRACT

A method including applying a wetting agent to air-laid pulp to form an intermediate pulp and cold-pressing the intermediate pulp to form a moulded product. The pulp may be formed from a fibrous raw material. The wetting agent may include a functional additive such as a sol. A sol may include a solvent, an alkoxide, and optionally a catalyst. The air-laid pulp, intermediate pulp, and/or moulded product may be free or substantially free of thermoplastic polymers and/or hydrocarbon-based plastics. The moulded product may be a fibre-based bubble wrap. The fibre-based bubble wrap may be formed from reel-to-reel processes.

### INTRODUCTION

The present invention relates to the processing of pulp and methods of achieving the same. More particularly, the present invention relates to imparting one or more beneficial characteristics to a product formed from air-laid pulp.

Paper, cardboard and other materials are commonly used as packaging for commercial products. The material properties of a product, such as the permeability of packaging materials to water, oils and other fluids may be controlled through use of impermeable polymeric materials such as plastics, or composites. In many industries such as the food and beverages industry, polymeric materials such as thermoplastics may be applied to otherwise permeable media to facilitate the retention of liquid products within a particular packaging item. In other examples, lignin or cellulose based paper feedstocks may be subjected to high temperatures to treat, cure or fuse the lignin or cellulose present in the paper feedstock to seal the pore structure of the material. Similar methods may also be used to prevent the ingress of fluid into an item that may become compromised by exposure to water, air or other fluids. Where polymeric materials such as plastic are used, the plastic materials are generally manufactured from hydrocarbon feedstocks and their manufacture presents an associated environmental cost. The materials or chemicals used to manufacture such plastics and the associated by-products may also be toxic. Some plastics may also degrade over time or through use to produce microplastics or to otherwise release potentially harmful species. Similarly, in processes where paper feedstocks are subjected to high temperatures, energy efficiency is often poor and some processes result in the release of undesirable gas or vapour by-products. Consequently, there are ongoing health and environmental concerns in relation to the manufacture of many common paper and cardboard packaging materials.

Papers and cardboards are generally formed from mixtures of plant-based fibres. Raw materials rich in lignin and/or cellulose such as wood or plant material are the most common raw material feedstocks and these materials are processed into pulp from which paper products may be manufactured. Paper pulp exists in several different forms such as wet-pulp or dry pulp that may be used in the formation of paper and/or cardboard products with different properties and purposes. For the avoidance of doubt, the term ‘paper’ as used herein is intended to encompass ‘cardboard’ and so a cardboard product would be considered to be a paper product for the purposes of the information provided herein. Moreover, the term ‘pulp’ is intended to mean a material formed from primarily plant-based fibrous material.

Wet pulps are pulp materials that use a liquid-based solvent as a carrying medium for the fibrous raw material medium during processing. The liquid carrying medium for wet-pulp is usually water due to its abundance, availability and relatively low cost. Wet pulps are typically formed by shredding and/or masticating a raw material feedstock in a volume of water to disperse the fibrous material and form the pulp. The wet-pulp is then transferred via one or more optional further processes to a press, mould, or similar device where the pulp may be shaped or formed into sheets. Wet-pulp as a raw material may be more than 90% water by weight. Products formed from wet-pulp may contain in excess of 50% liquid by weight following shaping and so much of this liquid must generally be removed prior to use. The residual liquid carrying medium is usually removed via one or more drying processes. The formation of a product from wet-pulp therefore requires significant volumes of water and large amounts of energy throughout the manufacturing process. Large volumes of water may also require to be cycled for long periods of time, which makes wet-pulp processes vulnerable to bacterial or fungal growth within manufacturing apparatus. To address this issue large quantities of disinfectant, antibacterial, or anti-fungal agents are often circulated through the manufacturing system to prevent an adverse accumulation of bacteria and/or fungi. The spent disinfectant must also be disposed which represents additional cost and poses further environmental challenges.

Dry pulps may be formed by drying wet-pulp or by otherwise utilising formation processes that forego the use of liquid carrying media such as water. In general, dry pulps have a high capacity to absorb water and so are often used to form absorbent products such as nappies, tissues, feminine hygiene products, and the like. Fluff pulp, or air-laid pulp, sometimes referred to as ‘airlaid’ pulp, in particular forgoes the use of water as a processing medium and utilises air or other gases as a means of carrying fibres. In general, air-laid pulp is shredded and reformed or re-laid by carrying and/or spinning the fibres in a gaseous medium which is often air. The air-laid pulp may be treated with one or more sizing agents prior to or during the carrying and/or spinning process to impart one or more characteristics to the air-laid pulp. Some air-laid pulp is formed from softwood due to the material's propensity to produce lengthy fibres of low density. Air-laid pulp may form products with different characteristics than those produced from wet-pulp. For example, air-laid pulp may be isotropic. In another example, air-laid pulp may have a greater pore volume than an equivalent wet-pulp which has been subsequently dried. This property makes fluff pulp or air-laid pulp particularly beneficial for the formation of products which must carry a proportionally high volume of liquid such as cleaning pads or wet wipes. The formation of a product from dry pulp generally involves treatment of the pulp with plastics or a binder which are exposed to high temperatures to melt the plastic or binder prior to the use of a mould or press to impart a desired shape. Air-laid pulp is not traditionally used to form products that require rigidity, strength, or fluid impermeability as the open, porous and ‘fluffy’ nature of the material makes it uniquely suited to applications that may take advantage of these properties and characteristics.

The properties of rigidity, strength, and water or gas resistance or impermeability are desirous in paper products used for the packaging and storage of perishable goods such as food and drink. Paper and cardboard packaging may need to protect a product stored or contained within the packaging. Papers and cardboards are not inherently fluid resistant or impermeable due to the material's intrinsic pore structure and so papers for packaging are typically treated or processed to provide a fluid barrier, material strength, or other resistances. Wet-pulp derived products are often coated with a plastic coating following formation to allow the product to resist the ingress of fluids and/or to provide strength to the material. Dry pulp derived products may be subjected to a hot-press process where the pulp has been optionally coated with a plastic or polymer precursor. The application of heat during the hot-press process is believed to ‘set’ or ‘cure’ the lignocellulosic fibres in the paper pulp and any plastic or polymer precursor applied to the pulp prior to the hot-press step. In practice, ‘hot-press’ processes for pulp processing operate at temperatures of around 100° C. to 300° C. as these temperatures are believed to cause the physical and chemical structure of the lignocellulosic fibres to change, thus providing a material with mechanical characteristics similar to plastics. Merely cold-pressing a pulp to form a product in the absence of heat and/or a polymer coating is not generally understood to provide a strong and/or impermeable product as the fibres are not bound into a rigid structure and the pore structure of the product is believed to remain at least partially open.

The inventor of the present invention has appreciated that moulded products formed from air-laid pulps may be formed without the use of large volumes of water, high temperatures, hydrocarbon-based polymers and/or thermoplastics, and complex manufacturing apparatus. In particular, the inventor of the present invention has appreciated that moulded products formed from air-laid pulp may have one or more desirable characteristics including at least partial resilient deformability and/or smoothness. Furthermore, the inventor of the present invention has appreciated that a fluid resistant or fluid impermeable moulded paper product may be formed by applying a cold-press process to an air-laid pulp in the presence of a wetting agent and/or a functional additive such as a sol. Sols that may be used in the processes described herein are described in WO 2021/019220. The process may also impart the moulded product with one or more other desirable characteristics depending upon the process through which the product is formed and/or the wetting agent or functional additive used in the formation process.

According to one aspect of the invention, there is provided a method including: applying a wetting agent to air-laid pulp to form an intermediate pulp; and cold-pressing the intermediate pulp to form a moulded product. The air-laid pulp, intermediate pulp, and/or moulded product may be free or substantially free of thermoplastic polymers and/or hydrocarbon-based plastics. The method may further include applying a functional coating and/or barrier to the intermediate pulp or moulded product. The method may further include additionally pressing the air-laid pulp, intermediate pulp, or moulded product. The moulded product may be a water resistant or water impermeable moulded product. The wetting agent may be applied to the air-laid pulp by brushing, spraying, spray drying, rolling, dipping, dropping, injecting, transferring, submersion, immersion, mixing, spreading, blading, padding, or any combination thereof. The wetting agent may be applied to the air-laid pulp by spraying. Cold-pressing the intermediate pulp may be carried out at a temperature less than 100° C. Cold-pressing the intermediate pulp may be carried out at a temperature of less than 50° C. The air-laid pulp, intermediate pulp, and/or wetting agent may not heated above 60° C. prior to formation of the moulded product. Optionally, the air-laid pulp, intermediate pulp, and/or wetting agent may not be heated above 40° C. prior to formation of the moulded product. Cold-pressing the intermediate pulp may include: pressing the intermediate pulp into at least one mould, pressing the intermediate pulp between at least one plate and at least one other surface, or any combination thereof. The method may further include applying heat to dry the air-laid pulp, intermediate pulp, or product. The method may further include drying the air-laid pulp, intermediate pulp, or product without the direct application of energy. The wetting agent may include water. The wetting agent may include a sol. The sol may include a solvent, an alkoxide, and a catalyst. The sol may further include a biopolymer. The biopolymer may include a starch. The starch may include a cationic starch. The cationic starch may be selected from quaternary ammonium type cationic starch, tertiary ammonium type cationic starch, and any combination thereof. The biopolymer may include a flour. The flour may include 5 to 85% starch, 0 to 30% hemi-cellulose, 0 to 50% cellulose, 0 to 25% lignin, 0 to 35% protein and 0 to 25% ash. The flour may be selected from wheat flour, barley flour, lentil flour, bamboo flour, corn flour, oat flour, rye flour, buckwheat flour, rice flour, chickpea flour, green pea flour, or any combination thereof. The catalyst may be at least one of an acid and a base. The catalyst may be selected from hydrochloric acid, citric acid, nitric acid, acetic acid, sodium hydroxide, potassium hydroxide, ammonia, and any combination thereof. The alkoxide may be selected from silicon alkoxides, metal alkoxides, phosphorus alkoxides, and any combination thereof. The alkoxide may be selected from n-propyltriethoxysilane, tetrapropyl orthosilicate, titanium(IV) tert-butoxide, titanium(IV) isopropoxide, triethyloxysilane, methyltriethyloxysilane, triethoxy(octyl)silane, phenyl-triethoxysilane, titanium(iv) ethoxide, triethoxy-silylcyclopentane, (3-glycidyloxypropyl) trimethoxysilane, cyclopentyltriethoxysilane, 3-amino-propyltriethoxysilane, triethoxy-3-(2-imidazolin-1-yl)propylsilane, and any combination thereof. The solvent may include water, one or more alcohols, and any combination thereof. The solvent may include methanol, ethanol, isopropanol, butanol, ethylene glycol or any combination thereof. The wetting agent may include one or more functional additives. The one or more functional additives may include photoinitiators, resins, oils, dyes, salts, anti-microbial agents, mineral or other inorganic particles, surfactants, biopolymers, composite particles and/or metal particles. The wetting agent may deliver the one or more functional additives into the internal structure of the air-laid pulp. Cold-pressing the intermediate pulp may include applying a pressure of less than 300 kg/m² to at least a part of the intermediate pulp. Cold-pressing the intermediate pulp may include applying a pressure of about 350 kg/m², about 2000 kg/m², about 3000 kg/m² or about 6000 kg/m² to at least a portion of the intermediate pulp. Cold-pressing the intermediate pulp may include applying pressure to a portion of the intermediate pulp for a time of less than 1 second to up to 3 seconds, optionally wherein pressure is applied for less than 1 second. The moulded product may be a fibre-based moulded bubble wrap. The moulded product may be a food or beverage packaging product.

According to another aspect of the invention, there is provided a fluid resistant or fluid impermeable fibre-based packaging material including air-laid pulp and a sol including a solvent, an alkoxide, and optionally a biopolymer. The fibre-based packaging material may be a fibre-based bubble wrap. The fibre-based bubble wrap may be formed using a reel-to-reel process, a reel-to-sheet process, a sheet-to-reel process, or a sheet-to-sheet process. The fibre-based packaging material may be a fibre-based packaging peanut.

### BRIEF DESCRIPTION OF THE DRAWINGS

Examples of the present disclosure will now be described with reference to the following drawings, in which:

FIG. 1 shows a flow diagram of a method according to the present disclosure;

FIG. 2 shows a flow diagram of a method including various optional method steps which may be carried out within the scope of the present disclosure;

FIGS. 3A to 3E show cross-sections of fibre-based bubble wraps that may be formed using the methods disclosed herein.

### DETAILED DESCRIPTION

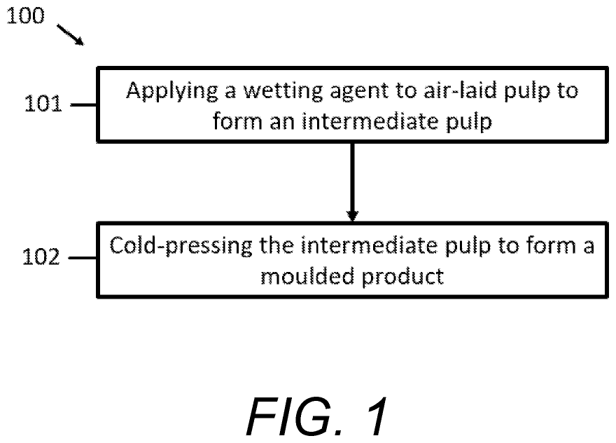

The method of the present disclosure aims to provide moulded air-laid pulp-based products with particular characteristics without the use of environmentally detrimental materials such as hydrocarbon-based plastics, the use of excessive quantities of water, or the application of excessive energy. FIG. 1 shows a flow diagram of a method 100 according to the present disclosure. The method 100 includes applying 101 a wetting agent to air-laid pulp to form an intermediate product, and cold-pressing 102 the intermediate pulp to form a moulded product.

The wetting agent may be any suitable wetting agent that allows the air-laid pulp structure to become at least partially malleable, deformable, mouldable, or otherwise shapeable. Without being bound by theory, the presence of a wetting agents is believed to act as a lubricant and/or to soften the fibrous material of the air-laid pulp such that the fibres may move or bend without breaking. The intermediate pulp formed following application of the wetting agent(s) to the air-laid pulp may therefore be shaped into a moulded product with relative ease without the need to heat the pulp significantly above ambient temperatures. The inventor of the present invention has also discovered that applying a wetting agent to air-laid pulp or similar pulp formed without the use of water or other liquids may impart fluid resistance to a moulded product formed from said pulp. The use of a wetting agent may also improve the surface smoothness, strength, and/or resilience of a product formed by moulding air-laid pulp. The application of a wetting agent may therefore improve the effectiveness of the cold-press process or reduce the cracking or breakage that occurs when air-laid pulp is pressed to form a moulded product. The products thus formed have been found to exhibit increased resistance to further or subsequent deformation when water or other liquids are applied to the final moulded product. The products may exhibit at least partial elasticity and/or be resiliently deformable. Without being bound by further theory, it is believed that the properties of fibres following the formation of air-laid pulp are uniquely suited to the formation of resilient and resiliently deformable products under pressure due to the absence of water from the internal structure of the air-laid pulp. It is further believed that the wetting agent applied during the formation process hydrates the fibre surface and initiates physiochemical reactions within the fibre matrix at an early stage that would otherwise be initiated by later exposure of the moulded product to water or other liquids. Consequently, the hydration and related reactions initiated by early application of the wetting agent to the air-laid or similar pulp may be prevented or reduced to occur to a more limited extent when further water or other liquids are applied to the finished moulded product. The moulded product may therefore better resist deformation, damage, or decomposition via exposure to water or other liquids after the formation of the moulded product. Wetting the air-laid pulp may also improve the efficiency of forming moulded air-laid pulp products by allowing the pulp to be processed at greater speed.

The wetting agent may include one or more functional additives. The one or more functional additives, where present, may be selected to impart one or more characteristics, properties or other behaviours to the air-laid pulp, intermediate pulp and/or moulded product. In some examples, the one or more functional additives may include photoinitiators, resins, oils, dyes, salts, anti-microbial agents, mineral or other inorganic particles, surfactants, biopolymers, composite particles and/or metal particles, or any combination thereof. The one or more functional additives may include one or more adhesives or binders. While the methods disclosed herein may be used to impart functionality to a product without the use of plastics, one or more plastic functional additives may be added to, or included as part of, the wetting agent used in the disclosed methods should the use of plastics be desired. The wetting agent may deliver the one or more functional additives onto the surface and/or into the internal structure of the air-laid pulp. Without being bound by theory, the functional characteristics imparted to air-laid pulp, intermediate pulp and/or moulded products with which a wetting agent with a functional additive is used may arise due to: the formation of a coating upon one or more surfaces of the air-laid pulp, intermediate pulp and/or moulded product; and/or the filling of pore volume and/or internal void space with one or more functional additives delivered into the pore volume and/or internal void space by the wetting agent. Moreover, in some situations, during or following application, some functional additives may at least partially form a transient nanodispersion, microdispersion or suspension in addition to the formation of a cross-linked coating. A cross-linked coating and/or the transient nanodispersion, microdispersion or suspension may perform a filling function by partially or fully blocking or obstructing otherwise porous or permeable passages on the surface of a product. Therefore, coating a product with a functional additive may result in a combination of a functional additive coating including discrete functional or reactive particles. Moreover, some functional additives may be present in solution or fine suspension and so be carried into internal void spaces of a product or intermediate product by a wetting agent. When a product or intermediate product is subsequently dried or otherwise treated then the functional additive may partially or fully fill and/or coat the internal void spaces of a product or intermediate product. One example of a functional additive that may act in this manner is a sol. The wetting agent including one or more functional additives may therefore act as coating, filler and binder simultaneously for materials of a porous and/or permeable nature.

The wetting agent may be a liquid. The wetting agent may comprise, consist, or consist essentially of water, one or more alcohols, any other suitable solvent such as an organic solvent, or any combination thereof. Where the solvent comprises an organic solvent, the organic solvent may comprise white spirit. Where present, the one or more alcohols of the solvent may comprise methanol, ethanol, butanol, ethylene glycol, isopropanol, industrial denatured alcohol, isomers of any preceding alcohol such as tert-butanol, any other suitable alcohol, and any combination thereof. The wetting agent may include, consist of, or consist essentially of water. The wetting agent may include, consist or, or consist essentially of a sol. In this context, the term ‘sol’ refers to a dispersion of colloidal particles in a liquid solvent. A sol may also be referred to as a sol mixture. Many sols formed from small colloidal particles are substantially clear and colourless. For example, sols formed from silicon-based functional materials will generally be clear and colourless as the particles forming the sol are sufficiently small that they do not scatter light. Some sols formed from larger particles may be coloured and/or at least partially opaque. For example, sols formed from titanium-based functional materials may be visibly white. Sols may form impermeable and/or anti-microbial and/or alternatively functional coating, filler, and/or binder compositions when applied to a range of materials. Consequently, sols may be used as a barrier and/or as an anti-microbial coating, filler, and/or binder composition and may provide other functionalities such as hydrophobicity, oleophobicity, anti-fouling, anti-biofouling, stain resistance, optical transparency, optical opacity, anti-reflectivity, colour, and adhesion promotion. Sols used as a barrier may provide a barrier to liquids, vapours and/or gases such as oxygen. Sols may comprise readily available natural materials that ensure the resulting sols are inexpensive. Furthermore, some sols have been shown to provide a durable and thermally resistant coating, demonstrating that sols may form resilient and long-lasting functional coatings.

A sol may be formed by dispersing one or more materials of suitably small particle size in a solution. Some sols may further comprise additional components such as a catalyst or functional components. Sols may be at least partially hydrolysed and/or at least partially condensed. The sols suitable for use in the methods of the disclosure may be any sol that may be applied, coated or incorporated into an air-laid pulp to impart a beneficial property or characteristic to the resulting product formed from the intermediate pulp thus formed. Sols suitable for use in the present disclosure will generally comprise a functional material and a solvent. The functional material may be present in the sol in any suitable proportion. For example, the functional material may be present in the sol in an amount of about 0.1%, about 0.5%, about 1%, about 2%, about 3%, about 4%, about 5%, about 6%, about 7%, about 8%, about 9%, about 10%, about 11%, about 12%, about 13%, about 14%, about 15%, about 20%, about 25%, about 30%, about 35%, about 40%, about 45%, or any other suitable quantity by total weight of sol. In an example, the methods of the disclosure may involve the use of sols comprising a solvent, a functional metal alkoxide, and optionally a biopolymer and/or optionally a catalyst. The term ‘metal alkoxide’ includes alkoxides comprising metals, organically modified alkoxides comprising metals, alkoxides comprising metalloids, and organically modified alkoxides comprising metalloids. The solvent used in the formation of the sol may comprise water, one or more alcohols, any other suitable solvent, or any combination thereof. Where present, the one or more alcohols may comprise methanol, ethanol, butanol, ethylene glycol, isopropanol, industrial denatured alcohol, isomers of any preceding alcohol such as tert-butanol, any other suitable alcohol, and any combination thereof. Bio-solvents such as bio-ethanol may also be used. Prior to its use as awetting agent, the sol may be combined with one or more further solvents, wherein the further solvents are the same as or different from the solvents used in the formation of the sol. Combination of the sol with one or more further solvents may initiate the precipitation of the sol such that it may be applied as a wetting agent during the time period across which the sol precipitates. Methods of initiating precipitation of sols are described further in WO 2021/160979. The biopolymer, where present, may comprise starch-based polymer, hemi-cellulose-based polymer, cellulose-based polymer, lignin-based polymer, chitosan-based polymer, any other suitable biopolymer or modified biopolymer, and any combination thereof. The sol may additionally, or alternatively, comprise one or more flours derived from natural materials. Suitable flours may include oat flour, barley flour, rye flour, wheat flour, rice flour, bamboo flour, lentil flour, chickpea flour, pea flour, corn flour, or any combination thereof. Where the sol comprises a functional metal alkoxide, the alkoxide will generally conform to the general formula M(OR)ₓ or R_{C}-M(OR)ₓ, where “M” denotes any metal forming the metal alkoxide which may hydrolyse in the presence of a suitable solvent. “R” and “R_{C}” denote alkyl radicals of typically 1 to 30 carbon atoms which may take any suitable form such as straight chain, branched, aromatic or complex. “x” will generally equate to the valence of the corresponding metal ion “M”. In an example, R may be a methyl, ethyl, propyl or butyl radical. Where a metal ion “M” has a valency in excess of 1, each R group may be the same. R_{C} denotes any suitable organic group which will form and maintain a covalent bond with the metal “M” following hydrolysis of the alkoxide. In some examples, R and R_{C} may be the same. In other examples, R and R_{C} may be different. Any suitable metal alkoxide may be used. Examples of suitable metal alkoxides include Si(OR)₄, Ti(OR)₄, Al(OR)₃, Zr(OR)₃ and Sn(OR)₄ as well as R_{C}—Si(OR)₃, R_{C}—Ti(OR)₃, R_{C}—Al(OR)₂, R_{C}—Zr(OR)₂ and R_{C}—Sn(OR)₃. In specific examples, R may be the methyl, ethyl, propyl or butyl radical. In some specific examples, R_{C} may be a phenyl group, a cyclopentyl group, or any other suitable organic group capable of maintaining a covalent bond to the metal. The metal of the metal alkoxide may comprise silicon, titanium, aluminium, zirconium, tin, or any other suitable metal. In particular examples, the metal alkoxides may be selected from the group comprising Ti(isopropoxy)₄, Al(isopropoxy)₃, Al(sec-butoxy)₃, Zr(n-butoxy)₄, Zr(n-propoxy)₄, n-propyltriethoxysilane, tetrapropyl orthosilicate, titanium(IV) tert-butoxide, titanium(IV) isopropoxide, triethyloxysilane, methyltriethyloxysilane, triethoxy(octyl)silane, phenyl-triethoxysilane, titanium(iv) ethoxide, triethoxy-silylcyclopentane, (3-glycidyloxypropyl) trimethoxysilane, cyclopentyltriethoxysilane, 3-amino-propyltriethoxysilane, triethoxy-3-(2-imidazolin-1-yl)propylsilane, and any combination thereof. In selected examples, the metal alkoxides may be selected from the group comprising tetraethoxysilane, phenyltriethoxysilane, methyltriethyloxysilane, and any combination thereof. In further selected examples, the metal alkoxides may be selected from the group comprising tetrapropyl orthosilicate, titanium(IV) tert-butoxide, titanium(IV) isopropoxide, triethyloxysilane, methyltriethyloxysilane, triethoxy(octyl)silane, phenyl-triethoxysilane, titanium(iv) ethoxide, triethoxy-silylcyclopentane, (3-glycidyloxypropyl) trimethoxysilane, cyclopentyltriethoxysilane, or any combination thereof. In additional selected examples, the metal alkoxide may be selected from the group comprising Ti(isopropoxy)₄, Al(isopropoxy)₃, Al(sec-butoxy)₃, Zr(n-butoxy)₄, Zr(n-propoxy)₄, and n-propyltriethoxysilane-based alkoxides, and any combination thereof. Suitable catalysts for use in sols include at least one of an acid or a base. Examples of acid catalysts include hydrochloric acid, citric acid, nitric acid and acetic acid. Examples of basic catalysts include sodium hydroxide, potassium hydroxide and ammonia.

A sol may be prepared by dispersing a functional material of suitably small particle size in a solvent and optionally adding a catalyst. The functional material may be a particle with at least one dimension in the range of approximately 1 nm to 1 μm. An alternative method of making a sol involves dispersing a functional material in a solution which optionally comprises a catalyst and then adding a biopolymer and/or one or more other functional additives. Where a biopolymer and/or one or more other functional additives are present, a sol comprising a functional material may generally be stored for a period of time, prior to addition of the biopolymer and/or the one or more other functional additives. Additional functional additives may be added at any stage during the method of making the sol. For example, in a sol comprising a biopolymer the additional functional additive may be added before or after the biopolymer has been dispersed in a solution but before the alkoxide has been added, or alternatively, after the biopolymer and alkoxide have been added to the solution. One or more functional additives may be added at different stages of making the sol. The functional additives may be used to adjust the properties of the sol in the same manner as they may be used to adjust the properties of any wetting agent as described herein, e.g. to control viscosity, density or rheology of the sols; to make the sol suitable for UV, visible or IR curing; and/or may be used to add additional functionality to a coating, filler, and/or binder prepared using the sol, e.g. colour, pH sensitivity, conductivity, fluorescence. The functional additives used will vary depending on the intended use of the sol. Suitable functional additives include photoinitiators, resins, oils, dyes (including pH sensitive dyes and fluorescent dyes), salts, surfactants, composite particles, mineral or other inorganic particles (including carbonates, carbides, oxides, hydroxides, nitrates, bromides, and the like), anti-microbial agents, biopolymers, and metal particles (including alloys and particles comprising one or more metals and one or more additional non-metal components). The sols may be also formed without the presence of any additives, biopolymers or catalysts. More particularly, sols may be wholly or substantially free of additives and/or biopolymers and/or catalysts during formation and/or use.

Sols, when used in the method of the present disclosure, may be used without being modified before use. Thus, the moulded products prepared using sols in accordance with the method of the present disclosure may be prepared from air-laid pulp and a sol without the sol being modified before use. For example, a water-resistant or water-impermeable product may be prepared from an air-laid pulp using a sol that is substantially free of additives, i.e. the water resistant or water impermeable moulded product is prepared by applying the sol to an air-laid pulp in the absence of any functional additives. Alternatively, the sols which may be used in the method of the present disclosure may be modified before use. For example, sols, when used in the methods of the present disclosure, may be modified by diluting a sol with a solvent, combining a sol with functional additives or both diluting a sol with a solvent and combining a sol with functional additives. Suitable solvents for use in diluting the sol include the solvent used to disperse the alkoxide when forming a sol (sometimes referred to as the sol solvent), other solvents that are miscible with the sol solvent, or combinations thereof. The functional additives may be used to adjust the properties of a sol such as the rheology, density, or viscosity of the sol and/or may be used to add additional functionality to a product prepared using a sol. The functional additives used will vary depending on the intended use of the sol and suitable functional additives include photoinitiators, resins, salts and fluorescent dyes.

Sols are generally stable by definition. A sol may therefore be formed some time prior to use of the sol as part of the methods described herein. For example, the sol may be formed and stored for a period of up to 1 hour, up to 1 day, up to 1 week, up to 1 year, up to 10 years, or more prior to use of the sol in the methods of the present disclosure. However, the sol may also be formed immediately prior, less than 2 seconds prior, less than 15 seconds prior, less than 30 seconds prior, less than a minute prior, or less than an hour prior to use of the sol. The sol may be formed in geographical proximity to the location at which it will be used. Alternatively, the sol may be formed distant from the site at which the sol is to be used and then transported to that site. In an example, the sol may be formed at a manufacturing site in an on-line process a matter of seconds before it is applied to an air-laid pulp. In another example, the sol may be formed in an independent manufacturing facility and then transported by road, rail, air, sea, pipeline or equivalent to a geographically distinct site where the sol is applied to an air-laid pulp. More generally, sols may be formed distinct from the pulp to which the sol is to ultimately be applied, where appropriate. In such an example, the sol and the air-laid pulp to which the sol is to be applied will be brought together following formation of the sol. Alternatively, a sol may be formed around an air-laid pulp to which the sol is to be applied such that the formed sol coats the air-laid pulp and/or permeates the pulp immediately, substantially immediately, or shortly after formation.

Sols or other wetting agents that may be used in the method of the present disclosure may optionally include one or more biopolymers. The one or more biopolymers, where present, may include one or more polysaccharides. For example, the biopolymer may comprise starch-based polymer, hemi-cellulose-based polymer, cellulose-based polymer, lignin-based polymer, chitosan-based polymer, any other suitable biopolymer or modified biopolymer, and any combination thereof. The sol may additionally, or alternatively, comprise one or more flours derived from natural materials. Suitable flours may include oat flour, barley flour, rye flour, wheat flour, rice flour, bamboo flour, lentil flour, chickpea flour, pea flour, corn flour, or any combination thereof. The use of a biopolymer in the sols may act as a natural surfactant forming networks with negatively charged species such as alkoxides, where present.

Starches suitable for use in sols which may be used with the methods of the present disclosure include positively charged plant-derived starches or the synthetic and derivative equivalents thereof such as cationic starch. Other starches such as anionic or neutral starches may also be used depending on the desired properties of the sol. In some examples, starches and other polysaccharides may be combined in a single sol, which may help optimise the functionalities of the sol. Cationic starch suitable for use in sols which may be used in the methods of the present disclosure includes primary, secondary, tertiary and quaternary cationic starch. Quaternary ammonium type starch is cationic in both high pH and low pH solutions, whereas primary, secondary and tertiary ammonium type starch is only cationic in low pH solutions. Hence different types of cationic starch may be suited to different applications. Sols that include one or more starches or cationic starches may be water-impermeable and/or oil-impermeable and/or vapour-impermeable and/or gas-impermeable and/or anti-microbial and/or hydrophobic and/or oleophobic and/or anti-fouling and/or anti-biofouling and/or stain resistant and/or antireflective. In particular, quaternary ammonium type starch has been found to be particular effective at imparting anti-microbial properties to the sol. In general terms, anti-microbial sols may be anti-bacterial and/or anti-fungal and/or anti-viral and/or anti-algae and/or anti-parasitic. Sols including starches have also been shown to be effective in preventing the growth of Staphylococcus aureus, Pseudomonas aeruginosa, Escherichia coli and Enterococcus hirae.

Flours suitable for use in the sols which may be used in the methods of the present disclosure include positively or negatively charged plant-derived flours or the synthetic and derivative equivalents thereof. Other flours such as neutral flours may also be used depending on the desired properties of the sol. Different flours may be combined in a single sol, which may help optimise the functionalities of the sol. Additionally, or alternatively, the flour may be combined with one or more additional polysaccharides depending upon the desired properties and functionality of the sol. In general, plant derived flours are the powdered form of plant material such as wheat. Flours comprise a range of constituent ingredients including proteins, fats, sugars, starches, amino acids, vitamins and trace elements. The composition of a flour depends upon the composition of the material from which it was sourced. For example, an oat flour may contain a greater proportion of cellulose than a wheat flour. Example compositions of various plant flours that may be used in sols that may be used in the methods of the present disclosure are provided in Table 1. The flour used in sols which may be used in the methods the present disclosure may be selected from oat flour, barley flour, rye flour, wheat flour, buckwheat flour, rice flour, bamboo flour, lentil flour, chickpea flour, green pea flour, corn flour, and combinations thereof. Other plant-derived flours including starch, hemi-cellulose, cellulose, lignin or other polysaccharides may also be used.

TABLE 1
Example compositions of flours derived
from various plant materials

| | | Hemi- | | | | |
|---|---|---|---|---|---|---|
| | Starch | cellulose | Cellulose | Lignin | Protein | Ash |
| | (wt %) | (wt %) | (wt %) | (wt %) | (wt %) | (wt %) |
| Oat | 45-50 | 10-15 | 5-10 | 2-7 | 10-15 | 0-5 |
| Barley | 50-60 | 8-12 | 0-5 | 0-5 | 10-15 | 0-5 |
| Rye | 60-65 | 8-12 | 0-5 | 0-5 | 10-15 | 0-5 |
| Wheat | 65-70 | 6-10 | 0-5 | 0-5 | 10-15 | 0-5 |
| Rice | 60-80 | 10-15 | 5-10 | 2-7 | 5-10 | 5-25 |
| Bamboo | 5-15 | 20-30 | 40-50 | 15-25 | 0-5 | 0-5 |
| Lentil | 5-50 | 0-5 | 0-5 | 0-5 | 20-30 | 0-5 |
| Chickpea | 20-30 | 0-5 | 0-8 | 0-5 | 15-35 | 0-5 |
| Green pea | 22-45 | 0-10 | 0-10 | 0-10 | 10-25 | 0-5 |
| Corn | 65-85 | 0-10 | 0-5 | 0-5 | 5-15 | 0-5 |

In general, plant-derived flours that may be used in the sols which may be used in the method of the present disclosure may comprise 5 to 85 wt % starch, optionally in combination with 0 to 30 wt % hemi-cellulose, 0 to 50 wt % cellulose, 0 to 25 wt % lignin, 0 to 35 wt % protein and 0 to 25 wt % ash. Other suitable flours may comprise 20 to 80 wt % starch, optionally in combination with 5 to 30 wt % hemi-cellulose, 0 to 50 wt % cellulose, 0 to 25 wt % lignin, 0 to 35 wt % protein and 0 to 25 wt % ash. Yet other suitable flours may comprise 45 to 80 wt % starch, optionally in combination with 5 to 30 wt % hemi-cellulose, 0 to 50 wt % cellulose, 0 to 25 wt % lignin, 0 to 35 wt % protein and 0 to 25 wt % ash. A further flour that may be suitable for the sols of the present disclosure may comprise 45 to 70 wt % starch, optionally in combination with 5 to 15 wt % hemi-cellulose, 0 to 10 wt % cellulose, 0 to 7 wt % lignin, 10 to 15 wt % protein and 0 to 5 wt % ash. In other examples, a suitable flour may comprise 20 to 70 wt % starch, optionally in combination with 0 to 15 wt % hemi-cellulose, 0 to 10 wt % cellulose, 0 to 10 wt % lignin, 5 to 35 wt % protein and 0 to 25 wt % ash. Additionally or alternatively, a suitable flour may comprise 45 to 70 wt % starch, optionally in combination with 5 to 15 wt % hemi-cellulose, 0 to 10 wt % cellulose, 0 to 10 wt % lignin, 5 to 15 wt % protein and 0 to 10 wt % ash. Still further a flour that may be suitable for the sols of the present disclosure may comprise 45 to 85 wt % starch, optionally in combination with 0 to 15 wt % hemi-cellulose, 0 to 10 wt % cellulose, 0 to 10 wt % lignin, 0 to 15 wt % protein and 0 to 10 wt % ash.

The wetting agents described herein may be applied to any suitable air-laid pulp material prior to cold-pressing of the intermediate pulp thus formed to form a moulded product. For the avoidance of doubt, the term ‘air-laid pulp’ in the contents of the methods of the present disclosure refers to the pulp formed following the carrying, laying and/or spinning of fibrous material in a gaseous medium. As previously described herein, one or more sizing agents, binders or other additives may be used to treat the fibres prior to or during the laying process. In an example, the air-laid pulp may be formed at least partially from wood fibre. In another example, the air-laid pulp may be formed at least partially from non-wood plant fibres. In a yet further example, the air-laid pulp may be formed at least partially from synthetic fibres. The air-laid pulp may therefore comprise plant fibres, wood fibres, natural fibres, synthetic fibres, any other suitable fibres, or any combination thereof. The air-laid pulp may be air-laid pulp, fluff pulp, recycled pulp, any other suitable category and/or classification of pulp considered to constitute air-laid pulp, or any combination thereof. The air-laid pulp may comprise, consist, or consist essentially of wood-based fibres. The air-laid pulp may comprise, consist, or consist essentially of plant-based and/or natural-derived fibrous material. The air-laid pulp may be free, or substantially free, from synthetic fibres. The air-laid pulp may be free, or substantially free, from textile fibres. The air-laid pulp may be free, or substantially free, from water. The use of air-laid pulp is considered advantageous as air-laid pulp does not require the quantities of water, disinfectant, and other chemicals commonly associated with the production and/or processing of wet-pulp. The use of air-laid pulp in preference to wet-pulp is therefore environmentally beneficial. Where a wetting agent with particular functionality is used, the method may provide further advantages depending upon the wetting agents used. In an example, the sols disclosed herein are generally antimicrobial/antibacterial and so may allow for a further reduction or the elimination of disinfectant or similar agents in the production of a product. Antimicrobial and antibacterial products that do not require the use of additional or specific antimicrobial or antibacterial agents may be advantageous in applications in which a product is to be used in the food or drink industry where microbial growth is undesirable but some alternative disinfectant agents themselves may pose health risks to humans. Air-laid pulp also typically has a more open pore-structure than the equivalent wet-pulp or wet-laid pulp. The more open pore-structure may allow the wetting agent to better penetrate the structure of the air-laid pulp such that the wetting agent may better treat a greater proportion of the air-laid pulp structure and any functional additives and/or sols forming part of the wetting agent may be more thoroughly dispersed throughout the material. Where the air-laid pulp is a recycled pulp, the recycled air-laid pulp may be formed from or include material from one or more products that had previously been manufactured using the methods described herein. Where the recycled air-laid pulp includes material from a product formed using the methods of the present disclosure, the recycled air-laid pulp may retain at least a portion of the functional characteristics and/or components applied to the air-laid pulp during manufacture of the now recycled product. Where this applies, the recycled air-laid pulp may retain at least some of the functionality imparted by a functional additive and/or sol forming part of the wetting agent during its original manufacture. It may therefore be possible impart a desired property to a product formed from recycled air-laid pulp by reducing the amount of functional additive and/or sol applied to the air-laid pulp in proportion to the amount of functional additive and/or sol residual in the recycled material.

The method includes the application of a wetting agent to an air-laid pulp. The amount of wetting applied to the air-laid pulp will depend upon the wetting agent being used, the material forming the air-laid pulp to which the wetting agent is to be applied, and the desired characteristics of the intermediate pulp and/or product formed following application of the wetting agent to the air-laid pulp. In an example, 5 ml of wetting agent may be applied to a 10 cm² surface of an air-laid pulp. In another example, 100 ml of wetting agent may be applied to a 10 cm². In a yet further example, 2 litres of wetting agent may be applied to a 1 m² surface area of air-laid pulp. The quantity of wetting agent applied to the air-laid pulp may be determined based upon the dry weight of the air-laid pulp. For example, wetting agent with a weight equivalent to, or in excess of about 1%, about 2%, about 3%, about 4%, about 5%, about 6%, about 7%, about 8%, about 9%, about 10%, about 12%, about 14%, about 16%, about 18%, about 20%, about 22%, about 24%, about 26%, about 28%, about 30%, about 35%, about 40%, about 45%, about 50%, about 60%, about 70%, about 80%, about 90%, about 100%, about 150%, or about 200% of the dry weight of the air-laid pulp may be added. In the methods described herein, the term ‘intermediate pulp’ is used to describe a pulp material to which a wetting agent has been applied. The wetting agent may be applied to the air-laid pulp by any suitable means including, but not limited to, brushing, spraying, spray drying, rolling, dropping, injecting, transferring, submersion, immersion, mixing, spreading, blading, padding, or any combination thereof. In an example, it may be advantageous to apply the wetting agent to the air-laid pulp by spraying techniques. In another example, it may be advantageous to apply the wetting agent to the air-laid pulp by one or more roller-based techniques. In examples where the air-laid pulp is free, or substantially free, of water then application of 100% wetting agent by dry weight will result in an intermediate pulp of approximately 50% wetting agent and 50% pulp. Similarly, in examples where 200% wetting agent by weight of dry air-laid pulp is applied, the intermediate pulp will include approximately 33% by weight of pulp and approximately 66% wetting agent. Even if a mass of wetting agent in excess of the mass of dry material is applied, the total wetting agent content of the intermediate pulp will remain below the 90% or more water present in wet-pulp applications.

Applying a wetting agent or a wetting agent including a functional additive may allow different volumes or masses of air-laid pulp to adhere together. Applying a wetting agent or a wetting agent including one or more functional additives to a surface of an air-laid pulp, and then contacting the surface to which the wetting agents has been applied with another surface of a different volume or mass of air-laid pulp may allow the volumes or masses of air-laid pulp to adhere together. In an example, applying a wetting agent or a wetting agent including a functional additive, such as a sol, to a thin sheet of air-laid pulp prior to contact the sheet of air-laid pulp with a second sheet of air-laid pulp may allow the two sheets of air-laid pulp to adhere together prior to further processing and/or formation of a moulded product.

The method includes cold-pressing the intermediate pulp to which a wetting agent has been applied to form a moulded product. A cold-press process in this context involves the application of pressure to a material without excessively heating the material or needlessly applying additional energy to the material beyond the mechanical force involved in the compression. In an example, no additional heat energy may be provided to the process. In another example, the cold-press process may involve actively cooling the material being pressed. This may be achieved by flowing a coolant through one or more conduits present in the cold-press apparatus, performing the cold-press in a cold room or atmosphere, or any other suitable means of cooling. In other examples, the cold-press method may be performed at room temperature or ambient temperature suffice that no steps are taken to increase the temperature of the material being pressed beyond that which would normally be experienced by pressing such material in an ambient temperature and pressure environment. The cold-press process, cold-press apparatus, or material subjected to the cold-press process may therefore be at a temperature of less than about −10° C., less than about −5° C., less than about 0° C., less than about 5° C., less than about 10° C., less than about 15° C., less than about 20° C., less than about 25° C., less than about 30° C., less than about 35° C., less than about 40° C., less than about 45° C., less than about 50° C., less than about 60° C., less than about 70° C., less than about 80° C., less than about 90° C., and/or less than about 100° C. It may be advantageous to carry out the cold-press process at a temperature in excess of the freezing point of one or more components of the wetting agent. In an example where the wetting agent includes water, the cold-press process may be carried out at temperatures in excess of 0° C. but less than 25° C. In an example, the cold-pressing the intermediate pulp is carried out at a temperature less than 100° C. In another example, cold-pressing the intermediate pulp is carried out at a temperature of less than 50° C. In general, the methods of the present disclosure using a cold-press method may be carried out such that the air-laid pulp, intermediate pulp, and/or wetting agent are not heated above, or used at a temperature of over, about 35° C., about 40° C., about 45° C., about 50° C., about 55° C., about 60° C., about 70° C., about 80° C., about 90° C., or about 100° C. prior to formation of the moulded product.

The cold-press process used in the method of the present disclosure may be carried out at any suitable pressure. In general, the cold-press process used in the methods of the present disclosure may be carried out at a reduced or lower pressure than would be required to process wet-pulp material, or pulp materials including thermoplastics or hydrocarbon-based polymers. The cold-press process may apply pressures of less than 25000 kg/m², less than 5000 kg/m², less than 4000 kg/m², less than 3000 kg/m², less than 2000 kg/m², less than 1000 kg/m², less than 500 kg/m², less than 300 kg/m², less than 250 kg/m², less than 200 kg/m², less than 150 kg/m², less than 100 kg/m², less than 50 kg/m², less than 40 kg/m², less than 30 kg/m², less than 20 kg/m², less than 10 kg/m², or any other suitable pressure to the intermediate pulp to form the moulded product. For example, the cold-press process may apply pressures of about 200 kg/m², about 300 kg/m², about 400 kg/m², about 500 kg/m², about 600 kg/m², about 700 kg/m², about 800 kg/m², about 900 kg/m², about 1000 kg/m², about 2000 kg/m², about 3000 kg/m², about 4000 kg/m², about 5000 kg/m², about 6000 kg/m², about 7000 kg/m², about 8000 kg/m², about 9000 kg/m², about 10000 kg/m², or more. In one particular example, a pressure of 6000 kg/m² may be used. In another particular example, a pressure of 3000 kg/m² may be used. In yet another particular example, a pressure of 2000 kg/m² may be used. In another further example, a pressure of 350 kg/m² may be used. Cold-pressing the intermediate pulp may comprise pressing the intermediate pulp into at least one mould, pressing the intermediate pulp between at least one plate and at least one other surface, or any combination thereof. The product may therefore be formed or otherwise shaped using one or more moulding shapes, templates or casts. The term ‘mould’ is used herein to generally define a component of an apparatus including a shaped recess portion into which the intermediate pulp may be directed to shape the intermediate pulp. Moulds typically provide an entry aperture or apertures for the intermediate pulp to enter the shaped recess on a single side of the recess such that the three-dimensional shape of the recess is completed when the mould is brought together with another mould or surface during the pressing process. Cold-pressing the intermediate pulp may therefore include passing the material through an aperture wherein the aperture is formed from at least one roller comprising one or more shaped mould depressions and at least one other surface. For example, cold-pressing an intermediate pulp may involve passing the intermediate pulp between two rollers wherein at least one roller comprises one or more shaped mould depressions such that pressure is applied to the intermediate pulp and a moulded product is formed in the shape of the one or more shaped mould depressions. In another example, cold-pressing the intermediate pulp may involve placing the intermediate pulp into a mould and then pressing the intermediate pulp with a plate or counter-shape such that it occupies the shape of the mould, plate, and/or counter-shape. In one example, the intermediate pulp may be placed in a first positive or negative mould and then a second corresponding positive or negative mould shape is applied to shape the intermediate pulp. In such an example, the first mould and second mould may include a positive mould and a negative mould. Pressure may be applied using another mould portion, pressure plate, or other suitable pressure application means. Returning to the example of the positive and negative mould, either the positive or negative mould may apply pressure by pressing or being pressed upon the intermediate pulp residing in the other positive or negative mould. Moulds or mould apparatus, in general, may include one or more drainage channels, conduits, pathways, or the like, to allow any excess fluid to be drained from the intermediate pulp when pressure is applied during the cold-press process. The cold-press process may apply pressure to the intermediate pulp for any suitable period of time. Advantageously, the method of the present disclosure allows a moulded product to be formed using pressure applied to the intermediate pulp for only a short amount of time. The pressure may be applied to the intermediate pulp for a period of less than about 20 seconds, less than about 15 seconds, less than about 10 seconds, less than about 8 seconds, less than about 6 seconds, less than about 4 seconds, less than about 2 seconds, less than about one second, or less than about half a second. For the avoidance of doubt, the application of pressure in this context may refer to the application of pressure to all or part of a given volume or mass of intermediate pulp. In an example, pressure may be applied to the intermediate pulp for less than about 1 second. In another example, pressure may be applied to the intermediate pulp for less than about 0.5 seconds. In one particular example of a cold-press process, the intermediate pulp may be processed into a moulded product using a reel-to-reel process, a reel-to-sheet process, a sheet-to-reel process, or a sheet-to-sheet process. In sheet-to-reel or sheet-to-sheet processes, sheets of raw pulp material are fed into the apparatus and processed before being fed to a reel system. In this manner, batch and/or non-continuous processes may form a reel of moulded product which may then be used in one or more continuous or intermittently continuous processes. In reel-to-reel, or reel-to-sheet processes, the intermediate pulp may form one continuous mass which is fed through rollers comprising one or more shaped mould depressions at high speed. The pressure used in such an arrangement need only be sufficient to form the moulded shape. The application of wetting agent prior to pressing the intermediate pulp ensures that the intermediate pulp is suitably malleable for high-speed processing while the resulting minimal contact time with the cold-press apparatus and relatively low pressure prevent the intermediate pulp fibres from becoming damaged.

Cold pressing the intermediate pulp forms a moulded product. The term ‘product’ as used herein is intended to include intermediate, work in progress and unfinished products and their components in addition to otherwise finished goods and articles. For example, a moulded product formed from the cold-pressing of intermediate pulp may be a finished article such as a paper shape, a ready-to-use cardboard pot, or the like. In other examples, the product may be an intermediate component which is used to form or assemble a larger product. The product may be a water resistant or water impermeable product. Where the product is a water resistant or water impermeable product, the water resistance or water impermeability may be imparted to the product by cold-pressing an intermediate pulp to which an impermeability-promoting functional additive has been applied. A sol used as at least part of a wetting agents may promote formation of a water or gas resistant or water or gas impermeable product. The methods of the present disclosure may therefore be used to form products such as packaging materials. In one example, the mould, press, or template may be shaped such that the intermediate pulp is formed into fibre-based bubble wrap which includes raised and lowered portions with the raised portions encasing a hollow interior to replicate the function of standard bubble wrap. In another example, the mould, press, or template may be shaped such that the intermediate pulp is formed into spherical, hemi-spherical, substantially spherical, and/or substantially hemi-spherical shapes. The product formed by the methods described herein may therefore include a water resistant or water impermeable fibre-based packing material. The water resistant or water impermeable fibre-based packing material may be a water resistant or water impermeable fibre-based bubble wrap. Alternatively, the water resistant or water impermeable fibre-based packing material may be a water resistant or water impermeable fibre based sphere or hemi-sphere. Where the product is a water resistant or water impermeable fibre-based sphere or hemi-sphere, the product may be used in place of packaging particles such as packing ‘peanuts’. Other uses include the formation of 3D-shaped products, cups such as coffee cups, container lids, cup lids such as coffee cup lids, bottle components, trays, any other suitable 3D-shape, or the like. In one particular example, the product may form a shaped packaging insert to protect a boxed electronic product, item of white goods, or similar object which may benefit from packaging material shaped to conform to a particular product. In effect, the shape and dimensions of the product formed from the methods of the present disclosure may be limited only by the limitations of shapes and configurations imparted by available pressing apparatus, moulds, and the like. The product may therefore include a three-dimensional shape including air-laid pulp and one or more wetting agents. In another example, the product may include a three-dimensional shape including air-laid pulp and one or more sols.

The air-laid pulp, intermediate pulp, and/or moulded product may be free or substantially free of hydrocarbon-based polymers and plastics. Therefore, the air-laid pulp or intermediate pulp used in the method of the disclosure, and/or the product formed using the method of the disclosure may have no, or substantially no components sourced from oil and gas feedstocks. In many traditional products formed from pulp, hot processes at temperatures of up to 300° C. or more are used to form impermeable barriers from plastics or hydrocarbon-based polymers applied to the intermediate pulp. Application of high temperatures either using a hot-press process or exposure of the product to sufficient heat for a period of time is believed to melt the plastic or hydrocarbon-based polymer to form an impermeable barrier. The inventor of the present invention has understood that application of an impermeability-promoting functional additive as part of the wetting agent, such as a sol, to a pulp in the absence of plastic or hydrocarbon-based polymers followed by a hot-press method at traditional temperatures of up to 300° C. or more does not always form a water or gas impermeable product. However, applying an impermeability-promoting wetting agent as described herein to an air-laid pulp and using a cold-press method does promote formation of a fluid resistant or fluid impermeable product. Without being bound by theory, fluid resistance or fluid impermeability promoting wetting agents such as sols described herein are believed to form network structures that obstruct the pore structure of the fibrous material and prevent passage of fluid. Where the components of the fluid resistance or fluid impermeability promoting functional additive are selected to impart one or more additional or alternative functions, the formed network may reside on or close to the surface of the fibrous product such that the network is able to provide functionality at the interface point of the fibrous product. Furthermore, it is believed that the use of a hot-press step at high temperatures such as 120° C. causes liberation of volatile gases or the evaporation of residual water or other species present in the fibre structure at a sufficiently rapid rate such that some of the pore network of the fibrous product becomes opened, thus allowing fluid to permeate the fibrous product. The use of a hot-press process at temperature in excess of those described in relation to the present disclosure may therefore prevent the formation of an impermeable product depending on the stage of manufacturing at which the high temperature hot-press process is applied. A cold-press process does not result in the volatilisation of such species at a sufficient rate, if at all, therefore allowing the fluid impermeability to remain intact as the material does not rupture to accommodate escaping fluids. It is also believed that compressing the structure of the fibrous product using the cold-press processes described herein compacts the available pore volume of the fibre structure thus reducing the available flowpaths for fluid flow and providing a reduced volume for sealing by the functional additive network. In an example, a sol applied to an air-laid pulp may permeate the pore volume and internal void volume of the air-laid pulp. When the resulting intermediate pulp is cold-pressed according to the methods described herein, the pore structure will at least partially collapse around the sol contained within, promoting contact between the internal pore and/or void walls with the sol. As the sol naturally dries, or is dried by other means, the sol may obstruct the pore volume of the fibrous material and form a coating on the outer and/or inner surface(s) of the cold-press moulded product, thus forming a fluid resistant or fluid impermeable barrier. Irrespective of the wetting agent used, the cold-press process described herein forms a product with enhanced smoothness due, at least in part, to the collapse of the pore structure in the product and/or the compression of the intermediate pulp during formation of the moulded product.

The method may include any number of additional method steps as desired. The method may include one or more additional wetting steps where liquid is applied to the air-laid pulp, intermediate pulp and/or product. Wetting the air-laid pulp, intermediate pulp and/or product may further aid in the processing of the air-laid pulp, intermediate pulp, and/or product through one or more additional processes forming part of the method. Where one or more further wetting steps are present, the wetting agent used in each step may be the same or different depending on the objective of the end user. In an example, a first wetting agent may be applied during a first wetting step to impart the property of water resistance or water impermeability to the moulded product. A second wetting step may then occur to impart a desired optical characteristic to the moulded product. The method may include the application of a functional coating and/or barrier to the intermediate pulp or moulded product. The functional coating may be formed from any material selected to impart one or more desired properties to the intermediate pulp and/or product. The functional coating and/or barrier may be a water-based coating and/or barrier, or may be formed from a water-based functional material. For example, the functional coating may be formed from one or more sols as described herein. The functional coating may be formed from a material selected to promote hydrophobicity, oleophobicity, anti-fouling, anti-biofouling, stain resistance, anti-microbial properties, optical transparency, optical opacity, anti-reflectivity, colour, adhesion promotion, any other suitable property, or any combination thereof. The method may include one or more additional cold-press steps. The additional cold-press steps may be carried out on the air-laid pulp, intermediate pulp and/or product as desired. The method may include one or more additional press steps wherein the air-laid pulp, intermediate pulp or product is subjected to pressure. It may be advantageous to exclude a hot-press step between the application of the sol to the air-laid pulp to form the intermediate pulp and any cold-pressing of the intermediate pulp. The method may include drying the air-laid pulp, intermediate pulp and/or product. Drying the air-laid pulp, intermediate pulp and/or product may involve air-drying the air-laid pulp, intermediate pulp, and/or product, heating and/or applying energy to the air-laid pulp, intermediate pulp, and/or product using a heater, oven, heat exchanger, heat gun, infrared source, any other suitable drying means, or any combination thereof. The method may include cutting, slicing, or otherwise freeing discreet shapes from a pulp matrix during one or more pressing steps. For example, where an intermediate pulp is present in a mould, the application of pressure via one or more further mould, plate, or equivalent components may also cut, slice, or separate portions of the intermediate pulp from other portions of the intermediate pulp present in the mould. In this manner, smaller products, smaller portions of products, or shapes that would not be achievable without cutting or slicing the intermediate pulp may be obtained using the methods described herein. For the avoidance of doubt, the product, intermediate product, or feedstock air-laid pulp material may be cut, sliced, and/or separated at any suitable point in the method. In one example, the product may be cut, sliced, and/or separated after the intermediate pulp has been pressed and/or dried. In another example, the product may be cut, sliced, and/or separated when the product is an intermediate product between any two other method steps. The process may further include applying pressure to the intermediate pulp prior to cold-pressing the intermediate pulp to form a moulded product. In an example, a mould may include fine details or areas that are sufficiently recessed that the intermediate pulp may experience difficulty in fully occupying or filling those portions of the mould. In these examples, the intermediate pulp it may be helpful to direct the intermediate pulp into the mould by application of a gas, pre-pressing techniques, tilting techniques, swirling techniques, or any other suitable process to ensure that the intermediate pulp occupies the entirety of the mould when the product is formed including any portions of a mould that are deeper or more regressed than other portions. The term ‘tilting techniques’ describes one or more processes where the mould aperture is moved out of a horizontal position such that gravity directs the intermediate pulp towards at least a portion of the mould cavity. The term ‘swirling techniques’ describes one or more processes where the intermediate pulp is directed towards at least a portion of the mould cavity in a spiral, corkscrew, or similar motion. Swirling techniques may also referred be to as ‘twist and push’ techniques.

Product defects may occur in moulded products where, for example, the moulds used to form the moulded products are of significant depth, complex in shape, or have areas of fine detail. Product defects may include tears, rips, holes, gaps, regions of missing material, regions of thinned materials, regions deficient in material, or the like. The method may include repairing or pre-emptively mitigating a product defect. Repairing a product defect includes placing a mitigating portion of dry air-laid pulp or intermediate pulp onto the product defect of the moulded product to repair the defect. Where dry air-laid pulp is used, the wetting agent already applied to form the intermediate pulp may cause the dry air-laid pulp to become wetted and/or adhere to the moulded product. Where intermediate pulp is used, the intermediate pulp will include wetting agent and so the intermediate pulp may adhere to the moulded product. In some examples, pressure may be applied to the dry air-laid pulp or intermediate pulp being used to repair the defect to promote adhesion. For example, pressures of about 200 kg/m², about 300 kg/m², about 400 kg/m², about 500 kg/m², about 600 kg/m², about 700 kg/m², about 800 kg/m², about 900 kg/m², about 1000 kg/m², about 2000 kg/m², or more may be used suffice that the pressure used to enact the repair does not damage or otherwise compromise the moulded product. Pre-emptively mitigating a product defect involves placing a mitigating portion of dry air-laid pulp and/or intermediate pulp in portions of a mould or similar apparatus known to be associated with defects prior to cold-pressing the intermediate pulp intended to form the moulded product. For example, where a mould with substantially cubic cavities is to be used, and where the corner sections of the substantially cubic mould have been identified as potential sources of product defects, then mitigating portions of air-laid pulp and/or intermediate pulp may be placed in one or more or each of the corner portions of the substantially cubic mould cavity prior to cold pressing the intermediate pulp to form a substantially cubic shape. Product defects may therefore be either pre-emptively mitigated or repaired following formation of the moulded product.

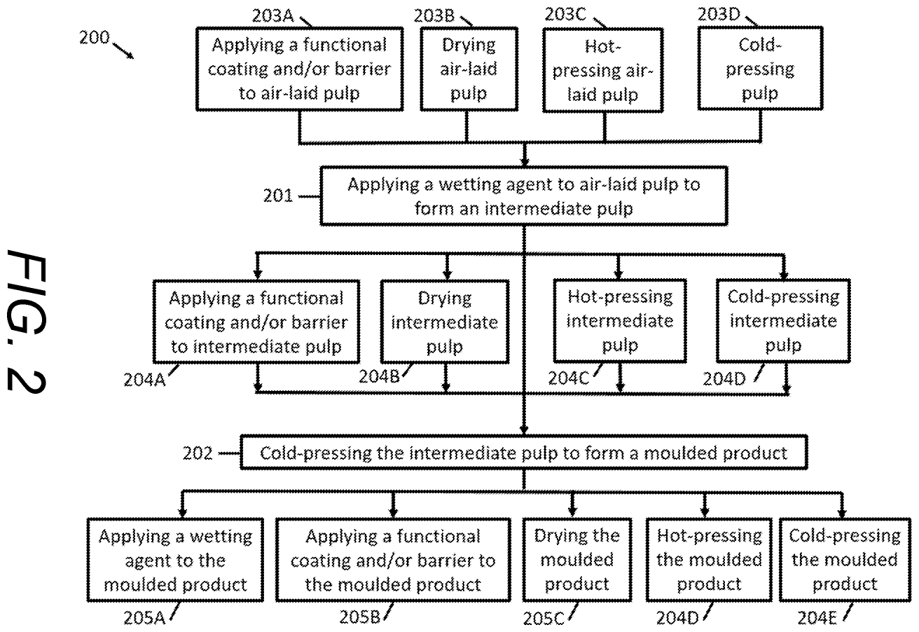

FIG. 2 shows a flow diagram of various permutations of methods 200 within the scope of the disclosure. The method 200 of FIG. 2 includes the method steps of applying 201 a wetting agent to air-laid pulp to form an intermediate pulp and cold-pressing 202 the intermediate pulp to form a moulded product. The method of FIG. 2 includes various optional additional method steps which may be performed prior to application of the wetting agent to the air-laid pulp. These steps include applying 203A a functional coating and/or barrier to the air-laid pulp, drying 203B the air-laid pulp, hot-pressing 203C the air-laid pulp, or cold-pressing 203D the air-laid pulp. Various further optional additional method steps are shown which may be performed prior to the cold-pressing of the intermediate pulp to form a moulded product. These steps include applying a wetting agent to the intermediate pulp, applying 204A a functional coating and/or barrier to the intermediate pulp, drying 204B the intermediate pulp, hot-pressing 204C the intermediate pulp, or cold-pressing 204D the intermediate pulp. Yet further optional additional method steps are shown which may be applied to the product following its formation by cold-press. These steps include applying 205A a wetting agent to the moulded product, applying 205B a functional coating and/or barrier to the moulded product, drying 205C the moulded product, hot-pressing 205D the moulded product, or cold-pressing 205E the moulded product. Although FIG. 2 shows a flowchart with just one of steps 203A to D, 204A to D and 205A to E being carried out as the method proceeds, the skilled person with the benefit of this disclosure will appreciate that any number of such steps could be carried out in any combination at any point in the method depending upon the objectives of the method.

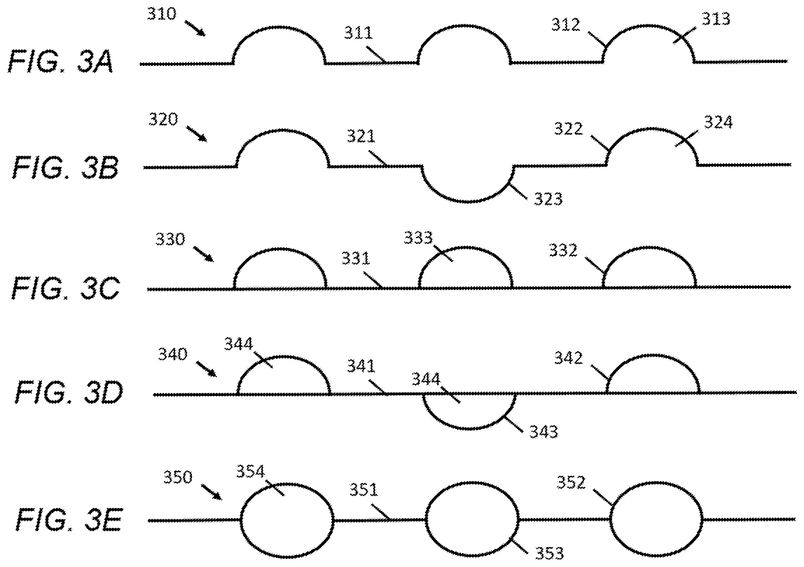

FIGS. 3A to 3E show examples of fibre-based bubble wrap that may be formed using the methods described herein. FIG. 3A shows a cross-section of a sheet of fibre-based bubble wrap 310 showing bridging portions 311 and hemi-spherical protrusions 312. The protrusions 312 each protrude in the same direction relative to the bridging portions 311 such that the protrusions 312 are all on the same side of the fibre-based bubble wrap 310 when the bridging portions 311 are positioned such that they are substantially linear and/or substantially planar in alignment. The hemi-spherical protrusions each define a cavity 313 within the sheet of fibre-based bubble wrap 310. The fibre-based bubble wrap 310 may be stacked with other sheets of fibre-based bubble wrap 310 by placing the protrusions 312 of one sheet into the cavities 313 of another sheet with which the fibre-based bubble wrap is to be stacked. FIG. 3B shows a cross-section of a sheet of fibre-based bubble wrap 320 showing bridging portions 321 and hemi-spherical protrusions 322 and 323. The protrusions 322 protrude upwards relative to the bridging portions 321 whereas protrusions 323 protrude downwards relative to the bridging portions 321 such that the upward protrusions 322 and downward protrusions 323 are each on different sides of the fibre-based bubble wrap 320 when the bridging portions 321 are positioned such that they are substantially linear and/or substantially planar in alignment. The hemi-spherical protrusions 322 and 323 each define a cavity 324 within the sheet of fibre-based bubble wrap 320. The fibre-based bubble wrap 320 may be stacked with other sheets of fibre-based bubble wrap 320 by placing the protrusions 322 and 323 of one sheet into the cavities 3324 of other sheets with which the fibre-based bubble wrap is to be stacked.

FIG. 3C shows a cross-section of a sheet of fibre-based bubble wrap 330 showing bridging portions 331 and hemi-spherical protrusions 332. In a manner similar to the bubble wrap shown in FIG. 3A, the fibre-based bubble-wrap 330 of FIG. 3C has protrusions 332 protrude upwards on the same side of bridging portions 331. The cavities 333 of the bubble wrap 330 are enclosed such that the cavities 333 contain an enclosed pocket of gas which may be air. While the fibre-based bubble wrap 330 is described with reference to enclosed cavities 333, the cavities may instead be at least partially filled with pulp and so may be formed from, and/or at least partially filled with, the same pulp material used to form the sheet of fibre-based bubble wrap 330. In this manner, the hemi-spherical protrusions 332 may be filled such that they are partially or substantially solid. FIG. 3D shows a cross-section of a sheet of fibre-based bubble wrap 340 showing bridging portions 341 and hemi-spherical protrusions 342 and 343. In a manner similar to the bubble wrap shown in FIG. 3B, the fibre-based bubble-wrap 340 of FIG. 3D has upward protrusions 343 and downward protrusions 344 that protrude from different sides of bridging portions 341 when the bridging portions 341 are arranged such that they are arranged in a substantially linear and/or substantially planar manner. The cavities 344 of the bubble wrap 340 are enclosed such that the cavities 344 contain an enclosed pocket of gas which may be air. While the fibre-based bubble wrap 340 is described with reference to enclosed cavities 344 the cavities may instead be at least partially filled with pulp and so may be formed from, and/or at least partially filled with, the same pulp material used to form the sheet of fibre-based bubble wrap 340. In this manner, the hemi-spherical protrusions 342 and/or 343 may be filled such that they are partially or substantially solid.

FIG. 3E shows another example of fibre-based bubble wrap 350 which may be formed using the methods disclosed herein. The fibre-based bubble wrap 350 includes bridging portions 351 and substantially spherical portions each formed from an upward protrusion 352 and a downward protrusion 353. Each substantially spherical portion includes an internal volume 354 which may be a hollow cavity or may be at least partially filled with solid. The solid in the internal volume 354, where present, may be the pulp material used to form the remainder of the sheet of fibre-based bubble wrap 350. The sheet of fibre-based bubble wrap 350 may be formed as one piece. For example, a positive and negative mould may be used to form the upwards and downward protrusions 352 and 353 from a single mass of pulp used in the manufacture of the fibre-based bubble wrap 350. Alternatively, fibre-based bubble wrap 350 may be formed by bringing together and adhering and/or sealing two sheets of the fibre-based bubble wrap 310 shown in FIG. 3A. The fibre-based bubble wrap of FIG. 3E may be subjected to one or more further processes following its formation. In one example, a cutting process may be used to free the substantially spherical portions formed from an upward protrusion 352 and a downward protrusion 353 from the bridging portions 351. The spherical portions thus freed from the sheet may then be used as packaging peanuts.

The fibre-based bubble wraps 310, 320, 330, 340, and 350 are only examples and other configurations of fibre-based bubble wrap are contemplated. The fibre-based bubble wrap may not have one or more or any bridging sections. For example, the protruding portions may be adjacent, substantially adjacent, tessellated, or the like. The fibre-based bubble wraps may be flexible or resiliently deformable with properties depending upon the density of the air-laid pulp, the properties of the wetting agent and/or any functional additives used in their formation. For example, using an air-laid pulp of greater grams per square metre (gsm) may increase the strength of the moulded product. Where a fibre-based bubble wrap has a plurality of protrusions, each of the protrusions may be on the same side of the fibre-based bubble wrap when the fibre-based bubble wrap is arranged to be substantially planer. Alternatively, one or more of the plurality of protrusions may be on a different side of the fibre-based bubble wrap from one or more other of the plurality of protrusions when the fibre-based bubble wrap is arranged to be substantially planar. While FIGS. 3A to 3E show fibre-based bubble wrap with protrusions that are hemi-spherical in nature, the protrusions may be any suitable three-dimensional shape such as cube-shaped, pyramid-shaped, irregular in shape, or any other suitable shape. Each protrusion of the fibre-based bubble wrap may be substantially identical. Alternatively, one or more or each protrusion of the fibre-based bubble wrap may be different from another protrusion of the fibre-based bubble wrap. The cross-sections in FIGS. 3A to 3E show rows of protrusions in a pattern which may be repeated in both the x and y axis of a sheet of bubble wrap substantially oriented in the x-y plane. Where protrusions are arranged protruding up and/or down from the x-y plane, the protrusions may be aligned in linear rows, alternating offset rows, or in any other suitable pattern. Alternatively, one or more protrusions may be arranged such that they are not arranged in a regular pattern. For example, the distribution of the protrusions may be irregular or substantially random. Where the fibre-based bubble wrap has a plurality of protrusions, each protrusion may be identical in size. For example, one or more dimensions of each protrusion of the plurality of protrusions may be substantially identical. Alternatively, one or more or each dimension of one or more or each protrusion of the plurality of protrusions may be different. The fibre-based bubble wrap may be formed using reel-to-reel processes which may use one or more roller moulds. In this manner, the fibre-based bubble wrap may be formed using a continuous or intermittently continuous process. Alternatively, the fibre-based bubble wrap may be formed using press apparatus or the like in batch processes. Other processes including a reel-to-sheet process, a sheet-to-reel process, or a sheet-to-sheet process may be used. The processes used to form the fibre-based bubble wrap may be used to form packaging peanuts by including one or more bladed sections in the mould such that protruding sections of the fibre-based bubble wrap are separated from the sheet of fibre-based bubble wrap. Where the fibre-based bubble wrap includes only hemispherical protrusions as shown in FIGS. 3A to 3D, the hemi-spherical portions may be brought together to form substantially spherical packaging peanuts. The skilled person, with the benefit of this disclosure, will understand that other shapes of protrusions may be adhered in a similar manner to form non-spherical shapes in a substantially identical manner. Where two or more fibre-based moulded products are adhered, they may be adhered using the wetting agent. If the adhesion is enacted prior to the drying of the moulded product then any wetting agent residual in the moulded product may be used, and may be sufficient, to enact the adhesion. In another example, a functional cellulose additive such as nano-cellulose may be used to adhere two or more fibre-based moulded products. The fibre-based bubble wrap may be used in applications such as packaging, cushioning, or the like. The fibre-based bubble wrap may also be used as at least part of another product, composite material, or the like. For example, the fibre-based bubble wrap may be used as part of an insulating air gap. Examples of applications that may use the fibre-based bubble wrap as part of an insulating air gap include construction materials, furniture, or the like. The fibre-based bubble wrap may impart strength or resilience to insulation that would otherwise involve an air or gas gap. The fibre-based bubble wrap may be positioned in and/or throughout an air or gas insulation cavity to strengthen the material or product including such an air or gas insulation cavity. The fibre-based bubble wrap may be used as part of a composite material. Where the composite material includes an insulating layer, the fibre based bubble wrap may be used as part of such an insulating layer to impart strength and/or fluid resistance or impermeability to the layer of the composite material. Where the fibre-based bubble wrap is used in a composite material, the fibre-based bubble wrap may impart one of more properties of the fibre-based bubble wrap to the composite material. Properties which may be imparted to the composite material by the fibre-based bubble wrap include strength, fluid resistance or fluid impermeability, thermal insulation, or any other property of the fibre-based bubble wrap.

The method of the present disclosure is therefore suited to the objectives of forming a fluid resistant or fluid impermeable fibre-based moulded product without the use of hydrocarbon-based polymers or plastics. The method further allows for a reduction in energy consumption in the formation of fluid resistant or fluid impermeable fibre-based products and may increase the speed at which fibre-based products may be manufactured in some circumstances. In particular, the methods disclosed herein allow for the formation of fibre-based products without the use of the quantities of water, disinfectant, and/or anti-bacterial agents that are associated with traditional wet-pulp processes. The moulded products formed using the methods of the present disclosure may be used in a range of industries such as the automotive, engineering, construction, aviation, marine, defence, electronics (including photo-electronics and sensors), energy (including batteries, energy storage and renewable energy), photonics, food, medical, household products, paper, adhesives, interior or exterior decoration, home improvement, additive manufacturing, oil and gas, separation and purification, fashion, general packaging, and cosmetics industries. In an example, the method of the present disclosure may be used in the formation of primary, secondary or tertiary packaging material for any suitable industry or purpose.

### EXAMPLES

The disclosure may be further understood in consideration of the following examples. All chemicals were used as received without further purification.

### Example 1

Water was rolled onto the surface of an air-laid pulp which was subsequently moulded using reel-to-reel cold press moulding to form a fibrous-bubble wrap.

Examples 2 to 20 provide various methods by which wetting agent sols that may be applied to a pulp may themselves be formed.

### Example 2 Formation of a Sol

Tetraethyloxysilane (100%, 5.5 ml) was added dropwise to a mixture of ethanol (7 ml) and aqueous HCl (0.1 M, 1.7 ml). The solution was stirred for approximately 40 hours until formation of a sol.

### Example 3 Formation of a Sol

Titanium (IV) Ethoxide (100%, 5.5 ml) was added dropwise to a mixture of ethanol (7 ml) and aqueous HCl (0.1 M, 1.7 ml). The solution was stirred for approximately 2 hours until formation of a sol.

### Example 4 Formation of a Sol

Methyltriethyloxysilane (100%, 7.5 ml) was added dropwise to a mixture of ethanol (15 ml) and aqueous HCl (0.1 M, 2 ml). The solution was stirred for approximately 1 hour until formation of a sol.

### Example 5 Formation of a Sol

Titanium isopropoxide (9 g) was added to a mixture of ethanol (6.5 ml) and aqueous HCl (0.1 M, 1.8 ml). The mixture was stirred for approximately 30 minutes until formation of a sol.

### Example 6 Formation of a Sol

Zirconium isopropoxide (8.5 g) was added to a mixture of ethanol (6.3 ml) and aqueous HCl (0.1 M, 1.6 ml). The mixture was stirred for approximately 1 hour until formation of a sol.

### Example 7 Formation of a Sol

Methyltriethyloxysilane (100%, 5.8 ml) was added dropwise to a mixture of ethanol (6.2 ml) and aqueous NaOH (0.1 M, 1.5 ml). The solution was stirred for approximately 30 minutes until formation of a sol.

### Example 8 Formation of a Sol

Aluminium isopropoxide (9.2 g) was added to a mixture of ethanol (6.5 ml) and aqueous HCl (0.1 M, 1.6 ml). The mixture was stirred for approximately 1 hour until formation of a sol.

### Example 9 Formation of a Sol

A silicon alkoxide precursor mixture (5 ml) composed of 50% tetraethyloxysilane and 50% methyltriethyloxysilane was added dropwise to a mixture of ethanol (10 ml) and aqueous NaOH (0.1 M, 2 ml). The solution was stirred for approximately 30 minutes until formation of a sol.

### Example 10 Formation of a Sol

Solution A—Titanium (IV) Ethoxide (5 ml) was added dropwise to ethanol (10 ml). Solution B—5 ml of solution A added to a silicon alkoxide precursor mixture (5.2 ml) composed of 50% tetraethyloxysilane and 50% phenyltriethoxysilane. The mixture was added dropwise to a mixture of ethanol (8.2 ml) and aqueous HCl (0.1 M, 1.8 ml). The solution was stirred at room temperature for approximately 1 hour until formation of a sol.

### Example 11 Formation of a Sol

A silicon alkoxide precursor mixture (5.2 ml) composed of 50% tetraethoxysilane and 50% phenyltriethoxysilane were added dropwise to a mixture of ethanol (10 ml) and aqueous HCl (0.1 M, 2 ml). The solution was stirred at room temperature for approximately 6 hours until formation of a sol.

### Example 12 Formation of a Sol

Cationic Starch (CS; 7 mg) was dispersed in a mixture of ethanol (10 ml) and aqueous HCl (0.1 M, 1.6 ml) to produce a solution with pH 2. To this stirred solution, silicon alkoxide precursor (5.2 ml) composed of 100% tetraethyloxysilane was added dropwise before stirring was continued for a further 8 hours.

### Example 13 Formation of a Sol

Cationic Starch (CS; 7 mg) was dispersed in a mixture of ethanol (10 ml) and aqueous HCl (0.1 M, 1.6 ml) to produce a solution with pH 2. To this stirred solution, silicon alkoxide precursor (5.2 ml) composed of 100% methyltriethyloxysilane was added dropwise before stirring was continued for a further 2 hours.

### Example 14 Formation of a Sol

Chitosan (6 mg) was dispersed in a mixture of ethanol (12 ml) and aqueous HCl (0.1 M, 2 ml) to produce a solution with pH 2. To this stirred solution, silicon alkoxide precursor mixtures (6 ml) composed of 50% tetraethoxysilane and 50% phenyltriethoxysilane were added dropwise before stirring was continued for a further 1.5 hours.

### Example 15 Formation of a Sol

Wheat flour (7 mg) was dispersed in a mixture of ethanol (8 ml) and aqueous NaOH (0.1 M, 2 ml) to produce a solution with pH 13. To this stirred solution, silicon alkoxide precursor mixtures (5.2 ml) composed of 50% tetraethyloxysilane and 50% methyltriethyloxysilane were added dropwise before stirring was continued for a further 30 minutes.

### Example 16 Formation of a Sol

Cationic Starch (CS; 5 mg) was dispersed in a mixture of ethanol (10 ml) and aqueous NaOH (0.1 M, 1.5 ml) to produce a solution with pH 13. To this stirred solution, methyltriethyloxysilane (5.2 ml) was added dropwise before stirring was continued for a further 20 minutes.

### Example 17 Formation of a Sol

Wheat flour (5 mg) was dispersed in a mixture of ethanol (6 ml), aqueous NaOH (0.1 M, 1 ml) and methyltriethoxysilane (1 ml) to produce a solution with pH 13. To this stirred solution, silicon alkoxide mixtures (1 ml) composed of 50% tetraethoxysilane and 50% phenyl-triethoxysilane were added dropwise before stirring was continued for a further 30 minutes.

### Example 18 Formation of a Sol

Cationic Starch (CS; 5 mg) was dispersed in a mixture of ethanol (7.6 ml) and aqueous HCl (0.1 M, 1.6 ml) to produce a solution with pH 2. To this stirred solution, silicon alkoxide precursor mixtures (5.2 ml) composed of 50% tetraethyloxysilane and 50% phenyltriethoxysilane were added dropwise before stirring was continued for a further 1 hour.

### Example 19 Formation of a Sol

Wheat flour (5 mg) was dispersed in a mixture of ethanol (6 ml), aqueous NaOH (0.1 M, 1 ml) and methyltriethoxysilane (1 ml) to produce a solution with pH 13. To this stirred solution, triethyloxysilane (1 ml) was added dropwise before stirring was continued for a further 1 hour.

### Example 20 Formation of a Sol

Wheat flour (5 mg) was dispersed in a mixture of ethanol (6 ml), aqueous NaOH (0.1 M, 1 ml) and methyltriethoxysilane (1 ml) to produce a solution with pH 13. To this stirred solution, silicon alkoxide mixtures (1 ml) composed of 50% tetraethyloxysilane and 50% phenyl-triethoxysilane were added dropwise before stirring was continued for a further 1 hour.

Examples 21 to 28 presented in Table 2 demonstrate various wetting agents comprising sols comprising various solvents, biopolymers and alkoxides.

TABLE 2
Matrix of further sol examples

| # | Solvent(s) | Alkoxide(s) | Biopolymer | Dilution |
|---|---|---|---|---|
| 21 | Ethanol, Ethylene | Tetraethylorthosilane, Triethoxy(octyl)silane, | Starch | 5% |
| | Glycol | Tetrapropylorthosilicate, Triethoxyphenylsilane | | |
| 22 | Ethanol, Tert- | Triethoxyoctylsilane, Tetraethylorthosilane | N/A | 5% |
| | Butanol | | | |
| 23 | Tert-Butanol | Methyltriethylsilane | Starch | 5% |
| 24 | Ethanol | Methyltriethylsilane | Starch | 5% |
| 25 | Ethanol | Zirconium(IV) butoxide | Starch | 5% |
| 26 | Ethanol | Aluminium Isopropoxide | Starch | 5% |
| 27 | Ethylene Glycol | Tetraethylorthosilane | Wheat Flour | 5% |
| 28 | Water | Triethoxy-3(2-imidazolin-1-yl)propylsilane | Starch | 5% |

Examples 29 to 35 provide examples of various methods within the scope of the present disclosure by which products may be formed.

### Example 29

The sols formed in examples 2, 3, 10, 13, 15, 16, 17, 18, 19, and 20 were each applied to an air-laid pulp using spraying techniques. Samples of each pulp were shaped using a press at pressures of around 350 kg/cm² and 2000 kg/cm², respectively, in the absence of heating. The pressed pulp products were allowed to air dry over a period of 2 weeks prior. Water droplets were placed on the surface of each of the shaped pulp products and allowed to rest for a period of 3 hours. After 3 hours, no water was seen to have permeated the surface of the pressed pulp products and observation was stopped.

### Example 30

The sol formed in example 21 was sprayed on to an air-laid pulp and a portion of the intermediate pulp of 2 cm length and 1.5 cm width was moulded using a cold-press process at 80° C. and 6000 kg force. The moulded product was dried prior to testing for water impermeability. Water droplets were placed upon the moulded product and left to rest for of 2 hours. No penetration of water into the surface of the product was observed.

### Example 31

The sol formed in example 22 was sprayed on to air-laid pulp and the intermediate pulp thus formed was moulded using a cold-press process to form a moulded product. The cold-pressed moulded product was then hot-pressed prior to testing for water impermeability. Water droplets were placed upon the moulded product and left to rest for of 2 hours. No penetration of water into the surface of the product was observed.

### Example 32

The sol formed in example 23 was sprayed on to air-laid pulp and the intermediate pulp thus formed was moulded using a cold-press process to form a moulded product. The cold-pressed product was then hot-pressed and then dried prior to testing for water impermeability. Water droplets were placed upon the moulded product and left to rest for of 2 hours. No penetration of water into the surface of the product was observed.

### Example 33

The sol formed in example 24 was sprayed on to air-laid pulp and the intermediate pulp thus formed was moulded using a cold-press process. A gas barrier coating was then applied to the cold-pressed product prior to treatment of the cold-pressed product using a hot-press. The resulting hot-pressed product was tested for water impermeability. Water droplets were placed upon the moulded product and left to rest for of 2 hours. No penetration of water into the surface of the product was observed.

### Example 34

The sol formed in example 25 was sprayed on to air-laid pulp and the intermediate pulp thus formed was moulded using a cold-press process. A gas barrier coating was then applied to the cold-pressed product prior to treatment of the cold-pressed product using a hot-press. The resulting hot-pressed product was dried and then tested for water impermeability. Water droplets were placed upon the moulded product and left to rest for of 2 hours. No penetration of water into the surface of the product was observed.

### Example 35

The sol formed in example 26 was sprayed on to air-laid pulp and the intermediate pulp thus formed was moulded using a cold-press process. The cold-pressed product was then dried before being subjected to further cold-press moulding. The double-cold-pressed product was then tested for water impermeability. Water droplets were placed upon the moulded product and left to rest for of 2 hours. No penetration of water into the surface of the product was observed.

### Example 36

Wetting agents including water, sols, and sols including biopolymers were applied to air-laid pulp prior to pressing the intermediate pulp thus formed for no more than 3 seconds at 2000 kg/m² at a temperature of 60° C. The process was repeated using ambient temperature. The press step was carried out using matched mould pairs shaped to form sheets including hemi-spherical raised portions on both sides of the intermediate pulp in the manner of bubble wrap. The product formed following the cold-press process was dried and then tested for water resistance and water impermeability. Each moulded product exhibited fluid resistance, a smooth surface finish, increased strength, and at least partial resilient deformability.

This process was performed with different ratios of mass of wetting agent to mass of dry air-laid pulp. A control sample using no wetting agent of any form and 100% dry pulp was also formed. The results using sol wetting agents are shown in Table 3 below.

TABLE 3
Product characteristics of various weight % of sol wetting agents

| | Surface | Fluid | | Resilient |
|---|---|---|---|---|
| | Smoothness | Resistance | Strength | Deformability |
| 0% wt. | Moderate | Permeable | Moderate | Moderate |
| 20% wt. | Moderate | Resistant | Moderate | Moderate |
| 40% wt. | Good | Impermeable | Moderate | Moderate |
| 50% wt. | Good | Impermeable | High | Good |
| 70% wt. | Good | Impermeable | High | Good |
| 80% wt. | Good | Impermeable | High | Good |
| 100% wt. | Good | Impermeable | High | Good |
| 125% wt. | Good | Impermeable | High | Good |
| 150% wt. | Best | Impermeable | High | Good |
| 200% wt. | Good | Impermeable | Best | Good |

### Example 37

The process of example 36 was repeated using moulds shaped to form spherical and hemi-spherical products. All spheres and hemi-spheres formed demonstrated water resistance or water impermeability in addition to resistance to deformation. A portion of the hemi-spherical products were pressed together following the press process to form spherical products. It was found that the planar surfaces of the hemi-spheres may be bonded without adhesive or further treatment if pressed together at this step. The best adhesion was achieved when the hemi-spheres were pressed together before the moulded product had fully dried. The spherical products and spheres formed from two hemi-spherical products also demonstrated impact resistance and some partial elastic deformation characteristics. Some of the spheres formed in this manner could be bounced in the manner of a ball.

### Example 38

The sols of examples 4, 8, 9, and 10 were prepared using different specific solvents at different specific points in the formation of each sol. The solvents trialed were: (i) tert-butanol; (ii) isopropanol; (iii) industrial denatured alcohol (IDA); (iv) white spirit; and (v) ethanol. Water was subsequently added to the sol to initiate precipitation and the time for each sol to fully precipitate was recorded. The time required for precipitation to complete varied depending upon which of solvents (i) to (v) were added prior to the addition of water as a precipitation initiator. Tert-butanol and isopropanol resulted in long relative precipitation times. IDA resulted in an intermediate precipitation time. White spirit and ethanol each resulted in a short precipitation time.

The experiment was repeated: (a) with the solvents added to the sol at the same time as the water precipitation initiator; and (b) with the solvents added to the sol after initial sol formation and shortly after the addition of the water precipitation initiator. The results of both experiments (a) and (b) were comparable with those obtained initially.

With the relative precipitation time established, the sols were each applied to air-laid pulp after the introduction of the water precipitation initiator and prior to the end of the precipitation process. The intermediate pulp thus formed was pressed in a cold-press process at room temperature at a pressure of 350 kg/m² for a period of 3 seconds. The moulded product was allowed to dry at room temperature.

What is claimed is:

1-42. (canceled)

43. A method comprising:
applying a wetting agent to air-laid pulp to form an intermediate pulp; and
cold-pressing the intermediate pulp to form a moulded product.

44. The method according to claim 43, wherein the air-laid pulp, intermediate pulp, and/or moulded product are free or substantially free of thermoplastic polymers and/or hydrocarbon-based plastics.

45. The method according to claim 43, the method further comprising applying a functional coating and/or barrier to the intermediate pulp or moulded product.

46. The method according to claim 43, the method further comprising additionally pressing the air-laid pulp, intermediate pulp, or moulded product.

47. The method according to claim 43, wherein the moulded product is a water resistant or water impermeable moulded product.

48. The method according to claim 43, wherein the wetting agent is applied to the air-laid pulp by brushing, spraying, spray drying, rolling, dipping, dropping, injecting, transferring, submersion, immersion, mixing, spreading, blading, padding, or any combination thereof.

49. The method according to claim 43, wherein cold-pressing the intermediate pulp is carried out at a temperature less than 100° C., optionally wherein cold-pressing the intermediate pulp is carried out at a temperature of less than 50° C.

50. The method according to claim 43, wherein the air-laid pulp, intermediate pulp, and/or wetting agent are not heated above 60° C. prior to formation of the moulded product, optionally wherein the air-laid pulp, intermediate pulp, and/or wetting agent are not heated above 40° C. prior to formation of the moulded product.

51. The method according to claim 43, wherein cold-pressing the intermediate pulp comprises: pressing the intermediate pulp into at least one mould, pressing the intermediate pulp between at least one plate and at least one other surface, or any combination thereof.

52. The method according to claim 43, the method further comprising applying heat to dry the air-laid pulp, intermediate pulp, or product and/or the method further comprising drying the air-laid pulp, intermediate pulp, or product without the direct application of energy.

53. The method according to claim 43, wherein the wetting agent comprises water and/or wherein the wetting agent comprises a sol.

54. The method according to any claim 53, wherein the wetting agent comprises a sol and the sol comprises a solvent, an alkoxide, and a catalyst, optionally wherein the sol further comprises a biopolymer.

55. The method according to claim 54, wherein the sol further comprises a biopolymer and the biopolymer comprises a starch.

56. The method according to claim 55 wherein the starch comprises a cationic starch, optionally wherein the cationic starch is selected from quaternary ammonium type cationic starch, tertiary ammonium type cationic starch, and any combination thereof.

57. The method according to claim 55 wherein the sol further comprises a biopolymer and the biopolymer comprises a flour, optionally wherein the flour comprises 5 to 85% starch, 0 to 30% hemi-cellulose, 0 to 50% cellulose, 0 to 25% lignin, 0 to 35% protein and 0 to 25% ash and/or wherein the flour is selected from wheat flour, barley flour, lentil flour, bamboo flour, corn flour, oat flour, rye flour, buckwheat flour, rice flour, chickpea flour, green pea flour, and any combination thereof.

58. The method according to claim 54, wherein the sol comprises a solvent, an alkoxide, and a catalyst, and the catalyst is at least one of an acid and a base, optionally wherein the catalyst is selected from hydrochloric acid, citric acid, nitric acid, acetic acid, sodium hydroxide, potassium hydroxide, ammonia, and any combination thereof.

59. The method according to claim 54, wherein the sol comprises a solvent, an alkoxide, and a catalyst, and the alkoxide is selected from silicon alkoxides, metal alkoxides, phosphorus alkoxides, and any combination thereof, optionally wherein the alkoxide is selected from n-propyltriethoxysilane, tetrapropyl orthosilicate, titanium(IV) tert-butoxide, titanium(IV) isopropoxide, triethyloxysilane, methyltriethyloxysilane, triethoxy(octyl)silane, phenyl-triethoxysilane, titanium(iv) ethoxide, triethoxy-silylcyclopentane, (3-glycidyloxypropyl) trimethoxysilane, cyclopentyltriethoxysilane, 3-amino-propyltriethoxysilane, triethoxy-3-(2-imidazolin-1-yl)propylsilane, and any combination thereof.

60. The method according to claim 54, wherein the sol comprises a solvent, an alkoxide, and a catalyst, and the solvent comprises water, one or more alcohols, and any combination thereof, optionally wherein the solvent comprises methanol, ethanol, isopropanol, butanol, ethylene glycol or any combination thereof.

61. The method according to claim 43, wherein the wetting agent comprises one or more functional additives, optionally wherein the one or more functional additives comprise photoinitiators, resins, oils, dyes, salts, anti-microbial agents, mineral or other inorganic particles, surfactants, biopolymers, composite particles and/or metal particles.

62. The method according to claim 61, wherein the wetting agent delivers the one or more functional additives into the internal structure of the air-laid pulp.

63. The method according to claim 43, wherein cold-pressing the intermediate pulp comprises applying a pressure of less than 300 kg/m² to at least a part of the intermediate pulp; or wherein cold-pressing the intermediate pulp comprises applying a pressure of about 350 kg/m², about 2000 kg/m², about 3000 kg/m² or about 6000 kg/m² to at least a portion of the intermediate pulp.

64. The method according to claim 43, wherein cold-pressing the intermediate pulp comprises applying pressure to a portion of the intermediate pulp for a time of less than 1 second to up to 3 seconds, optionally wherein pressure is applied for less than 1 second.

65. The method according to claim 43, wherein the moulded product is a fibre-based moulded bubble wrap and/or wherein the moulded product is a food or beverage packaging product.

66. A fluid resistant or fluid impermeable fibre-based packaging material comprising air-laid pulp comprising a moulded product formed by the method of claim 43, optionally wherein the fibre-based packaging material comprises a sol, said sol comprising a solvent, an alkoxide, and optionally a biopolymer.

67. The fibre-based packaging material of claim 66, wherein the fibre-based packaging material is a fibre-based bubble wrap, optionally wherein the fibre-based bubble wrap is formed using a reel-to-reel process, a reel-to-sheet process, a sheet-to-reel process, or a sheet-to-sheet process.

68. The fibre-based packaging material of claim 66, wherein the fibre-based packaging material is a fibre-based packaging peanut.
